(19) United States
(12) Patent Application Publication
(10) Pub. No.: US 2025/0365742 A1
(43) Pub. Date: Nov. 27, 2025

(54) METHOD, DEVICE AND COMPUTER READABLE MEDIUM FOR COMMUNICATIONS

(71) Applicant: Nokia Technologies Oy, Espoo (FI)

(72) Inventors: Renato Barbosa ABREU, Aalborg (DK); Timo Erkki LUNTTILA, Espoo (FI); Nuno Manuel KIILERICH PRATAS, Gistrup (DK); Yong LIU, Shanghai (CN); Jianguo LIU, Shanghai (CN); Laura Luque SANCHEZ, Nibe (DK); Thomas Haaning JACOBSEN, Nørresundby (DK)

(21) Appl. No.: 18/872,984

(22) PCT Filed: Jun. 17, 2022
(86) PCT No.: PCT/CN2022/099616

§ 371 Date: Dec. 9, 2024

(51) Int. Cl. H04W 72/25; H04W 72/0446; H04W 74/0808

(52) U.S. Cl. CPC H04W 72/25; H04W 72/0446; H04W 74/0808

(57) ABSTRACT

Embodiments of the present disclosure relate to method, device and computer readable media for communications. A first device obtains first information about a channel access procedure to be performed by a second device for a second sidelink transmission on a reserved resource. The reserved resource is subsequent to a first candidate resource in a candidate resource set of the first device. The first device determines an expected time interval of the channel access procedure based on the first information. If transmitting symbols of the first candidate resource overlaps with the expected time interval, the first device updates the candidate resource set for a first sidelink transmission to be performed by the first device. The first sidelink transmission does not disrupt the channel access procedure.

### TECHNICAL FIELD

Implementations of the present disclosure generally relate to the field of telecommunication, and in particular, to a method, device and computer readable medium for communications.

### BACKGROUND

Certain communication systems enable vehicle to everything (V2X) and device to device (D2D) communications to be performed. V2X communications can be based on communication technologies such as sidelink communication technologies. For this, sidelink resource pools and sidelink channels can be established for vehicles participating in such communications.

In V2X communications, there are two modes of resource allocation. In a first mode (also referred to as NR V2X mode 1 or mode 1 hereinafter), one terminal device may perform V2X communications with the other terminal device by using resources allocated by a network device. In a second mode (also referred to as NR V2X mode 2 or mode 2 hereinafter), one terminal device may perform V2X communications with the other terminal device by using resources autonomously selected in a resource pool by the one terminal device.

### SUMMARY

In general, example implementations of the present disclosure provide a method, device and computer readable medium for communications.

In a first aspect, there is provided a first device. The first device comprises at least one processor and at least one memory including computer program codes. The at least one memory and the computer program codes are configured to, with the at least one processor, cause the first device to: obtain first information about a channel access procedure to be performed by a second device for a second sidelink transmission on a reserved resource, the reserved resource being subsequent to a first candidate resource in a candidate resource set of the first device; determine an expected time interval of the channel access procedure based on the first information; and in accordance with a determination that transmitting symbols of the first candidate resource overlaps with the expected time interval, update the candidate resource set for a first sidelink transmission to be performed by the first device, wherein the first sidelink transmission does not disrupt the channel access procedure.

In a second aspect, there is provided a second device. The second device comprises at least one processor and at least one memory including computer program codes. The at least one memory and the computer program codes are configured to, with the at least one processor, cause the second device to: determine first information about a channel access procedure to be performed by the second device for a second sidelink transmission on a reserved resource; and transmit the first information to a first device.

In a third aspect, there is provided a method implemented at a first device. The method comprises: obtaining, at a first device, first information about a channel access procedure to be performed by a second device for a second sidelink transmission on a reserved resource, the reserved resource being subsequent to a first candidate resource in a candidate resource set of the first device; determining an expected time interval of the channel access procedure based on the first information; and in accordance with a determination that transmitting symbols of the first candidate resource overlaps with the expected time interval, updating the candidate resource set for a first sidelink transmission to be performed by the first device, wherein the first sidelink transmission does not disrupt the channel access procedure.

In a fourth aspect, there is provided a method implemented at a second device. The method comprises: determining, at a second device, first information about a channel access procedure to be performed by the second device for a second sidelink transmission on a reserved resource; and transmitting the first information to a first device.

In a fifth aspect, there is provided an apparatus. The apparatus comprises: means for obtaining, at a first device, first information about a channel access procedure to be performed by a second device for a second sidelink transmission on a reserved resource, the reserved resource being subsequent to a first candidate resource in a candidate resource set of the first device; means for determining an expected time interval of the channel access procedure based on the first information; and means for updating the candidate resource set for a first sidelink transmission to be performed by the first device in accordance with a determination that transmitting symbols of the first candidate resource overlaps with the expected time interval, wherein the first sidelink transmission does not disrupt the channel access procedure.

In a sixth aspect, there is provided an apparatus. The apparatus comprises: means for determining, at a second device, first information about a channel access procedure to be performed by the second device for a second sidelink transmission on a reserved resource; and means for transmitting the first information to a first device.

In a seventh aspect, there is provided a non-transitory computer readable medium. The non-transitory computer readable medium comprises program instructions for causing an apparatus to perform the method according to the third aspect.

In an eighth aspect, there is provided a non-transitory computer readable medium. The non-transitory computer readable medium comprises program instructions for causing an apparatus to perform the method according to the fourth aspect.

It is to be understood that the summary section is not intended to identify key or essential features of implementations of the present disclosure, nor is it intended to be used to limit the scope of the present disclosure. Other features of the present disclosure will become easily comprehensible through the following description.

### BRIEF DESCRIPTION OF THE DRAWINGS

Through the more detailed description of some implementations of the present disclosure in the accompanying drawings, the above and other objects, features and advantages of the present disclosure will become more apparent, wherein:

FIG. 1 illustrates an example communication network in which implementations of the present disclosure can be implemented;

FIG. 2 illustrates an example of a CCA slot in accordance with some implementations of the present disclosure;

FIG. 3 illustrates an example of acquisition of the COT by an initiating device via LBT Type 1 in accordance with some implementations of the present disclosure;

FIG. 4 illustrates an example of a contention window countdown procedure in accordance with some implementations of the present disclosure;

FIG. 5 illustrates examples of allowed gaps for which LBT Type 2 variant to be applicable in accordance with some implementations of the present disclosure;

FIG. 6 illustrates an example when a responding device has to acquire a new COT in accordance with some implementations of the present disclosure;

FIG. 7 illustrates an example of NR SL resource allocation in mode 2 in accordance with some implementations of the present disclosure;

FIG. 8 illustrates a flowchart of a legacy SL resource allocation method;

FIG. 9 illustrates a flowchart of a legacy method for forming the resource candidate set;

FIG. 10 illustrates an example of an SL slot structure in accordance with some implementations of the present disclosure;

FIG. 11 illustrates an example of how the selection of a candidate resource prior to a reserved resource may disrupt an LBT procedure of other UEs;

FIG. 12 illustrates a flowchart of an example method in accordance with some implementations of the present disclosure;

FIGS. 13A, 13B and 13C illustrate an example of SL resource selection in accordance with some implementations of the present disclosure, respectively;

FIG. 14 illustrates a flowchart of an example method in accordance with other implementations of the present disclosure;

FIG. 15 illustrates a flowchart of an example method in accordance with other implementations of the present disclosure;

FIG. 16 illustrates a simplified block diagram of an apparatus that is suitable for implementing embodiments of the present disclosure; and

FIG. 17 illustrates a block diagram of an example computer readable medium in accordance with some implementations of the present disclosure.

Throughout the drawings, the same or similar reference numerals represent the same or similar element.

### DETAILED DESCRIPTION

Principle of the present disclosure will now be described with reference to some example implementations. It is to be understood that these implementations are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other implementations whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example implementations. As used herein, the term “and/or” includes any and all combinations of one or more of the listed terms.

The terminology used herein is for the purpose of describing particular implementations only and is not intended to be limiting of example implementations. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the future fifth generation (5G) communication protocols, and/or any other protocols either currently known or to be developed in the future. Implementations of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), a NR Next Generation NodeB (gNB), a Remote Radio Unit (RRU), a radio header (RH), a remote radio head (RRH), Integrated Access and Backhaul (IAB) node, a relay, a low power node such as a femto, a pico, and so forth, depending on the applied terminology and technology. The network device is allowed to be defined as part of a gNB such as for example in CU/DU split in which case the network device is defined to be either a gNB-CU or a gNB-DU.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VoTP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. In the following description, the terms “terminal device”, “communication device”, “terminal”, “user equipment” and “UE” may be used interchangeably.

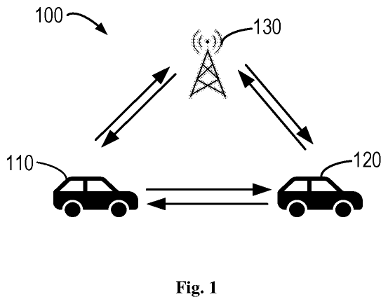

FIG. 1 illustrates a schematic diagram of an example communication network 100 in which implementations of the present disclosure can be implemented. As shown in FIG. 1, the communication network 100 may include a first device 110, a second device 120 and a third device 130. The third device 130 may communicate with the first device 110 and the second device 120 via respective wireless communication channels.

In this example, only for ease of discussion, the first device 110 and the second device 120 are illustrated as vehicles which enable V2X communications and the third device 130 is illustrated as a network device serving the devices 110 and 120. It is to be understood that the terminal device and the network device are only example implementations of the first device 110, the second device 120 and the third device 130, respectively, without suggesting any limitation as to the scope of the present application. Any other suitable implementations are possible as well.

It is to be understood that the number of devices in FIG. 1 is given for the purpose of illustration without suggesting any limitations to the present disclosure. The communication network 100 may include any suitable number of devices adapted for implementing implementations of the present disclosure.

The communications in the communication network 100 may conform to any suitable standards including, but not limited to, Global System for Mobile Communications (GSM), LTE, LTE-Evolution, LTE-Advanced (LTE-A), Wideband Code Division Multiple Access (WCDMA), Code Division Multiple Access (CDMA), GSM EDGE Radio Access Network (GERAN), Machine Type Communication (MTC) and the like. Furthermore, the communications may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols.

### 1. Unlicensed Operation Background

In some implementations, the communications in the communication network 100 may comprise sidelink (SL) communication. In sub-7 GHz unlicensed bands, the new radio (NR) coexistence with other systems (e.g. IEEE 802.11) is ensured via a Listen Before Talking (LBT) channel access mechanism. According to the channel access mechanism, a user equipment (UE) intending to perform an SL transmission needs first to successfully complete an LBT check, before being able to initiate the same transmission. Hereinafter, an LBT procedure may also be referred to as Clear Channel Assessment (CCA) or channel access procedure.

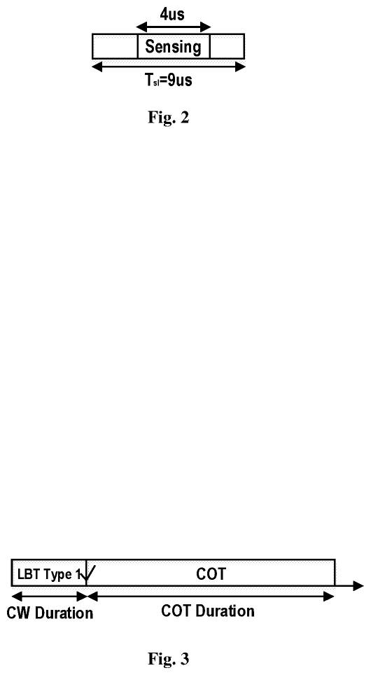

For a UE to pass an LBT check, it must observe the channel as available for a number of consecutive CCA slots. In sub-7 GHz, the duration of these slots is 9 μs, as depicted in FIG. 2. FIG. 2 shows that CCA slot has a duration Tₛₗ=9 us, where the energy sensing takes place during 4 us. The UE deems the channel as available in a CCA slot if the measured power (i.e. the collected energy during the CCA slot) is below a regulatory specified threshold which may depend on the operating band and geographical region.

When a UE initiates the communication (i.e. the UE takes the role of initiating device), this UE has to acquire the “right” to access the channel for a certain period of time—denoted in the regulations as the Channel Occupancy Time (COT)—by applying an “extended” LBT procedure where the channel must be deemed as free for the entire duration of a Contention Window (CW). This “extended” LBT procedure is commonly known as LBT Type 1 as specified in TS 37.213. This procedure is illustrated in FIG. 3.

Both of a CW duration and a COT duration in FIG. 3 depend on the Channel Access Priority Class (CAPC) associated with the UE's traffic, as shown in Table 1. Control plane traffic (such as PSCCH) is transmitted with p=1, while user plane traffic has p>1.

TABLE 1

| Channel | | | | | |
|---|---|---|---|---|---|
| Access | | | | | |
| Priority | | | | | |
| Class (p) | mₚ | CW_{min, p} | CW_{max, p} | T_{ulm cot, p} | allowed CWₚ sizes |
| 1 | 2 | 3 | 7 | 2 ms | {3, 7} |
| 2 | 2 | 7 | 15 | 4 ms | {7, 15} |
| 3 | 3 | 15 | 1023 | 6 ms or | {15, 31, 63, 127, |
| | | | | 10 ms | 255, 511, 1023} |
| 4 | 7 | 15 | 1023 | 6 ms or | {15, 31, 63, 127, |
| | | | | 10 ms | 255, 511, 1023} |

NOTE1:
For p = 3, 4, T_{ulm cot, p} = 10 ms if the higher layer parameter absenceOfAnyOtherTechnology-r14 or absenceOfAnyOtherTechnology-r16 is provided, otherwise, T_{ulm cot, p} = 6 ms.
NOTE 2:
When T_{ulm cot, p} = 6 ms it may be increased to 8 ms by inserting one or more gaps. The minimum duration of a gap shall be 100 us. The maximum duration before including any such gap shall be 6 ms.

Table 1 shows CAPC for UL. The contention window length in CCA slots associated with each CAPC has a minimum (CW_{min,p}) and maximum (CW_{max,p}). The duration of the COT is given by T_{ulm cot, p}.

Examples of behavior during the contention window countdown procedure are depicted in FIG. 4. It should be noted that if during the countdown procedure the LBT check fails in any CCA slot, the countdown procedure will stop and will only resume if the channel is deemed as free (i.e. the LBT check is successful) during a defer time.

Specifically, FIG. 4 shows LBT Type 1 contention window countdown procedure and examples on how it can be disrupted, In an example (a), when neither the defer time nor the countdown are disrupted (i.e., the channel is not detected as busy during a sensing slot). In an example (b), the defer time is disrupted (i.e., the channel is detected as busy during a defer time sensing slot). In an example (c), the contention window countdown is disrupted (i.e., the channel is detected as busy during a sensing slot of the countdown). In FIG. 4, T_{d} represents the defer time, Tₛₗ represents the CCA slot duration and N represents the number of CCA slots required to be deemed as free before the contention window countdown is complete.

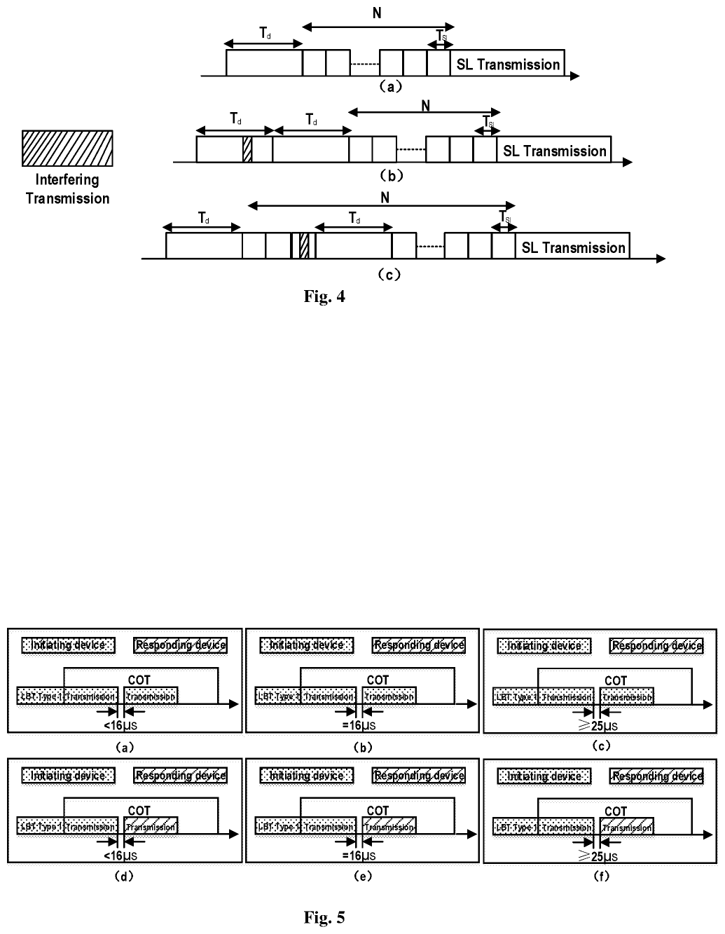

The UE initiating the transmission (also referred to as the initiating device) upon successfully completing the LBT Type 1 and performing a transmission, acquires the COT with duration associated with the corresponding CAPC. The acquired COT is valid even in the case where the initiating device pauses its transmission, although if the initiating device wants to perform a new transmission (within the COT) it is still required to perform a “reduced” LBT procedure. This “reduced” LBT procedure is commonly known as LBT Type 2 with the following variants:
Type 2A (25 μs LBT)—for SL transmissions within the initiating device acquired COT (in case the gap between two SL transmissions is ≥25 μs, as well for SL transmissions following another SL transmission), as depicted in examples (c) and (f) in FIG. 5;
Type 2B (16 μs LBT)—for SL transmission within the initiating device acquired COT (can only be used for SL transmissions following another SL with gap exactly equal to 16 μs), depicted in examples (b) and (e) in FIG. 5;
Type 2C (no LBT)—which can only be used for SL transmission following another SL, with a gap <16 μs and the allowed duration of the SL transmission ≤584 μs, as depicted in examples (a) and (d) in FIG. 5.

In addition, the examples (a), (b) and (c) show the case where the gap is between the two transmissions both from the initiating UE, while the examples (d), (e), and (f) show the case that the gap is between the two different transmissions from the initiating UE and the responding UE correspondingly.

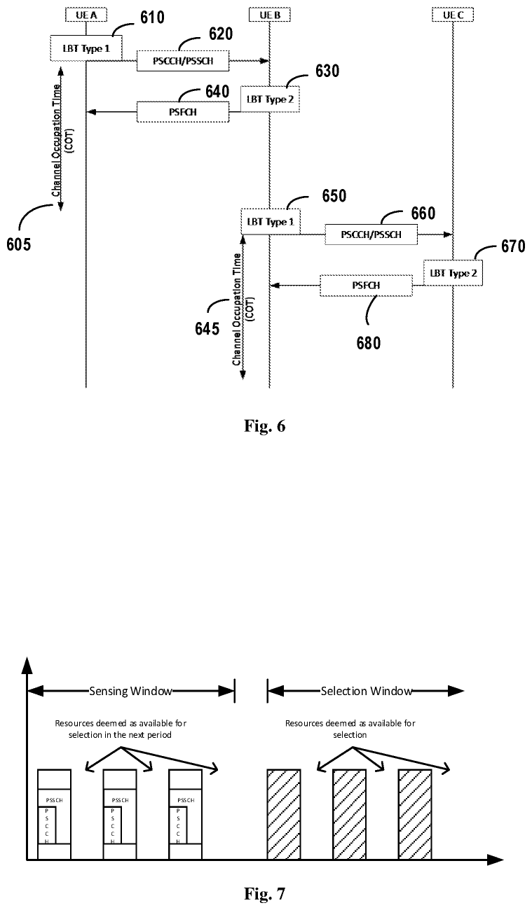

The initiating device may share its acquired COT with its intended receiver (also referred to as the responding device). For this purpose, the initiating device shall inform (e.g. via control signaling) the responding device about the duration of this COT. The responding device uses then this information to decide which type of LBT it should apply upon performing a transmission for which the intended receiver is the initiating device. In case the responding device transmission falls outside the COT, then the responding device will have to acquire a new COT using the LBT Type 1 with the appropriate CAPC. This will be described with reference to FIG. 6.

FIG. 6 illustrates an example when a responding device has to acquire a new COT. UE A acquires a new COT 605 using an LBT Type 1 procedure 610. UE A may transmit SL transmission 620 on PSCCH and/or PSSCH to UE B. In addition, UE A shares its acquired COT with UE B. UE B then uses this information to decide which type of LBT it should apply upon performing a transmission for which the intended receiver is UE A. For this purpose, UE A shall inform (e.g. via control signaling) UE B about the duration of the COT 605. In this example, upon receiving the SL transmission 620, UE B performs an LBT Type 2 procedure 630 and transmits SL feedback information 640 on PSFCH to UE A in response to a success of the LBT Type 2 procedure 630.

Because transmission from UE B to UE C falls outside the COT 605, UE B has to acquire a new COT 645 using an LBT Type 1 procedure 650 with the appropriate CAPC. UE B may transmit SL transmission 660 on PSCCH and/or PSSCH to UE C. In addition, UE B shares its acquired COT with UE C. UE C then uses this information to decide which type of LBT it should apply upon performing a transmission for which the intended receiver is UE B. For this purpose, UE B shall inform (e.g. via control signaling) UE C about the duration of the COT 645. In this example, upon receiving the SL transmission 660, UE C performs an LBT Type 2 procedure 670 and transmits SL feedback information 680 on PSFCH to UE B in response to a success of the LBT Type 2 procedure 670.

### 2. NR-SL Overview

NR SL has been designed to facilitate a user equipment (UE) to communicate with other nearby UE(s) via direct/SL communication. Two resource allocation modes have been specified, and a SL transmitter (TX) UE (such as the first device 110 or the second device 120) is configured with one of them to perform its NR SL transmissions. These modes are denoted as NR SL mode 1 and NR SL mode 2. In mode 1, a sidelink transmission resource is assigned or scheduled by a network device (such as the third device 130) to the SL TX UE, while a SL TX UE in mode 2 autonomously selects its SL transmission resources.

In mode 1, the network device is responsible for the SL resource allocation, and the configuration and operation are similar to the one over the Uu interface.

FIG. 7 illustrates an example of NR SL resource allocation in mode 2. In mode 2, SL UEs perform autonomously the resource selection with the aid of a sensing procedure. More specifically, a SL TX UE in NR SL mode 2 first performs a sensing procedure over the configured one or more SL transmission resource pools in order to obtain the knowledge of one or more reserved resources by at least one other nearby SL TX UE. Based on the knowledge obtained from sensing, the SL TX UE may select at least one resource from the available SL resources accordingly. In order for a SL UE to perform sensing and obtain the necessary information to receive a SL transmission, it needs to decode the sidelink control information (SCI). In Release 16, the SCI associated with a data transmission includes a 1st-stage SCI and 2nd-stage SCI.

### 2.1 NR SL Resource Allocation Mode 2

As mentioned above, in mode 2, each UE autonomously selects resources by decoding physical sidelink control channel (PSCCH) (or sidelink control information (SCI)) and performing RSRP measurement of at least one configured or pre-configured resource pool based on a procedure on a candidate resource pool during a sensing window interval.

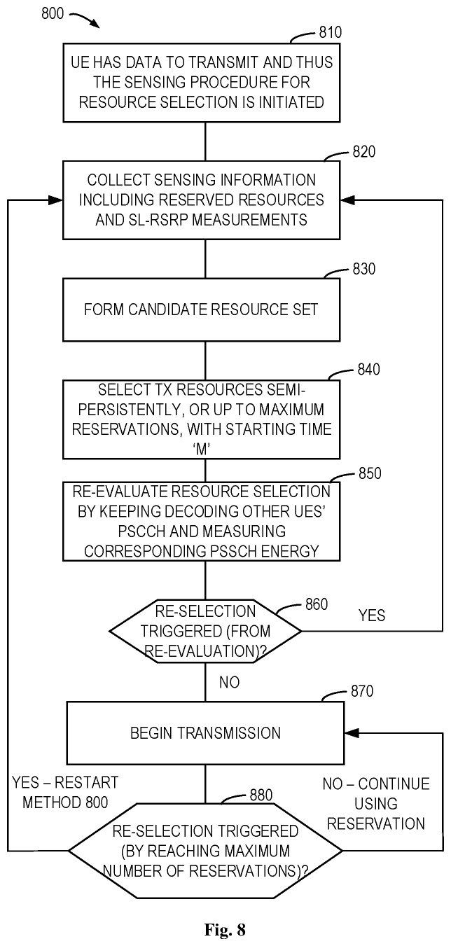

FIG. 8 illustrates a flowchart of a legacy SL resource allocation method 800. As shown in FIG. 8, at block 810, UE has data to transmit and thus the sensing procedure for resource selection is initiated.

At block 820, UE collects sensing information including reserved resources and SL-RSRP measurements.

At block 830, UE forms a candidate resource set.

At block 840, UE selects Tx resources semi-persistently, or up to maximum reservations, with starting time ‘m’.

At block 850, UE re-evaluates resource selection by keeping decoding other UEs' PSCCH and measuring corresponding PSSCH energy.

At block 860, UE determines whether resource re-selection is triggered (from re-evaluation).

If the resource re-selection is not triggered, UE begins transmission at block 870.

If the resource re-selection is triggered, the method 800 proceeds to block 820.

At block 880, UE determines whether resource re-selection is triggered by reaching maximum number of reservations.

If the resource re-selection is triggered by reaching maximum number of reservations, UE restarts the method 800 and method 800 proceeds to block 820. If the resource re-selection is not gered by reaching maximum number of reservations, UE continues using reservation and the method 800 proceeds to block 870.

In the method 800, regarding the block 810, the monitoring of the resource pool and acquisition of information to be used during the resource selection procedure can be done prior to the Tx UE knowing that it has a transmission to perform. In addition, regarding the block 830, after the Tx UE has acquired enough information from its monitoring of the resource pool it can form the candidate resource set.

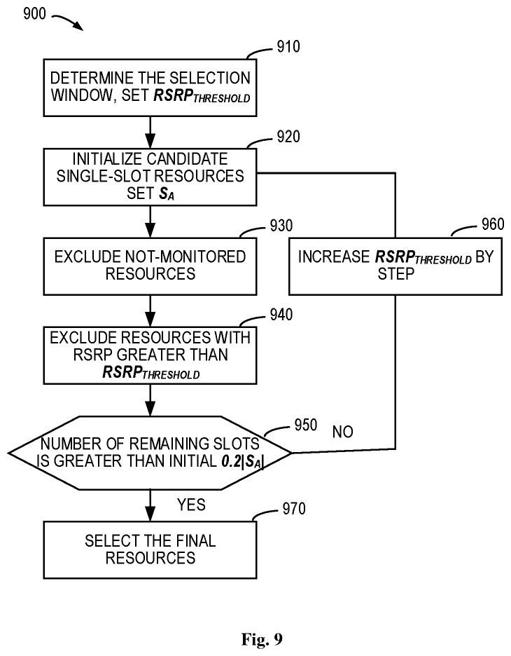

FIG. 9 illustrates a flowchart of a legacy method 900 for forming the resource candidate set. A method 900 occurs for resources within a candidate resource pool, which have been monitored during a sensing window interval. During this sensing window interval, UE collects the set of S_{A} of potential candidate resource slots that are within a defined selection window period and excludes all resources/slots which meet at least one of the following:
The UE has not monitored them during the sensing period (e.g. due to own transmission or other activities including DRX); and
The decoded SCI format 1-A indicates that the candidate slot is reserved and the corresponding measured RSRP is above a pre-configured RSRP_{threshold}.

Specifically, as shown in FIG. 9, at block 910, UE determines the selection window and set RSRP_{threshold}.

At block 920, UE initializes a candidate single-slot resource set S_{A}.

At block 930, UE excludes not-Monitored resources from the set S_{A}.

At block 940, UE excludes resources with RSRP greater than RSRP_{threshold} from the set Sa.

At block 950, UE determines whether the number of remaining slots is greater than |X. S_{A}|, where X=0.2, 0.35, or 0.5, |S_{A}| represents the initial total number of resources in the set S_{A}.

If the number of remaining slots is less than |X. S_{A}|, UE increases, at block 960, the RSRP_{threshold} by a step (i.e., RSRP_{threshold}=RSRP_{threshold}+step, where the step is currently defined to be 3 dB). Then, the method 900 proceeds to block 920.

If the number of remaining slots is greater than |X. S_{A}|, UE, at block 970, forwards the potential candidate slots to the higher for final resource selection.

### 2.2 SL Physical Layer Structure

The configuration of the resources in the sidelink resource pool defines the minimum information required for a RX UE to be able to decode a transmission, which includes the number of sub-channels, the number of PRBs per sub-channels, the number of symbols in the PSCCH, which slots have a PSFCH and other configuration aspects not relevant to this invention.

However, the details of the actual sidelink transmission (i.e., the payload) are provided in the PSCCH (1st-stage SCI) for each individual transmission, which includes: the time and frequency resources, the DMRS configuration of the PSSCH, the MCS, PSFCH, among others.

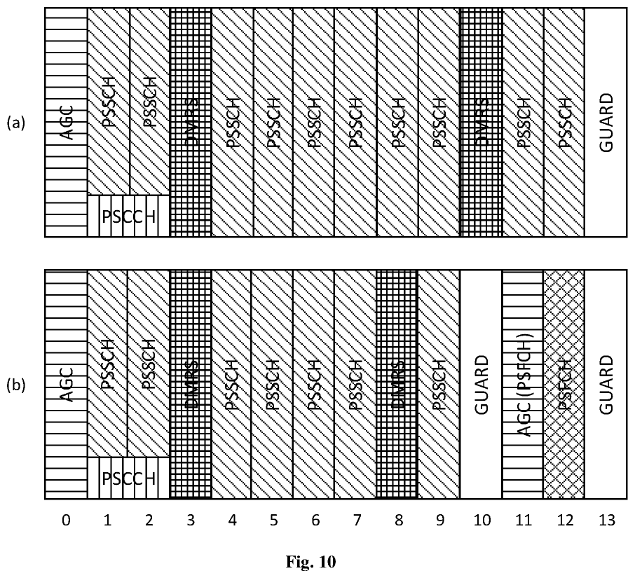

An example of the SL slot structure is depicted in FIG. 10, where it shows a slot with PSCCH/PSSCH in an example (a) and a slot with PSCCH/PSSCH where the last symbols are used for PSFCH in an example (b).

Table 2 shows PSSCH DMRS configurations based on the number of used symbols and duration of the PSCCH.

TABLE 2

| | DM-RS position l̅ | | | | | |
|---|---|---|---|---|---|---|
| | PSCCH duration 2 symbols | | | PSCCH duration 3 symbols | | |
| l_{d} in | Number of PSSCH DM-RS | | | Number of PSSCH DM-RS | | |
| symbols | 2 | 3 | 4 | 2 | 3 | 4 |
| 6 | 1, 5 | | | 1, 5 | | |
| 7 | 1, 5 | | | 1, 5 | | |
| 8 | 1, 5 | | | 1, 5 | | |
| 9 | 3, 8 | 1, 4, 7 | | 4, 8 | 1, 4, 7 | |
| 10 | 3, 8 | 1, 4, 7 | | 4, 8 | 1, 4, 7 | |
| 11 | 3, 10 | 1, 5, 9 | 1, 4, 7, 10 | 4, 10 | 1, 5, 9 | 1, 4, 7, 10 |
| 12 | 3, 10 | 1, 5, 9 | 1, 4, 7, 10 | 4, 10 | 1, 5, 9 | 1, 4, 7, 10 |
| 13 | 3, 10 | 1, 6, 11 | 1, 4, 7, 10 | 4, 10 | 1, 6, 11 | 1, 4, 7, 10 |

The configuration of the PSCCH (e.g., DMRS, MCS, number of symbols used) is part of the resource pool configuration. Furthermore, the indication of which slots have PSFCH symbols is also part of the resource pool configuration. However, the configuration of the PSSCH (e.g., the number of symbols used, the DMRS pattern and the MCS) is provided by the 1st-stage SCI which is the payload sent within the PSCCH and follows the configuration as depicted in Table 2.

As described in background, currently for SL communications operating with SL Mode 2, the UE determines the set of candidate single-slot resources by checking which single-slot resources are not reserved by other UEs based on received SCIs and whether the RSRP associated to each of these SCIs are below a threshold. Then, from that candidate single-slot resource set, the UE can uniform randomly select the required resources.

However, if a UE selects a candidate resource located immediately prior to a reserved resource, a transmission performed by the UE on the candidate resource may disrupt an LBT procedure and block a transmission performed by other UE on the reserved resource. This is clearly undesirable.

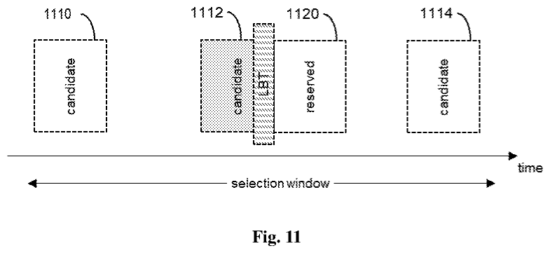

FIG. 11 illustrates an example of how the selection of a candidate resource prior to a reserved resource may disrupt the LBT procedure of the other UEs. In FIG. 11, a first UE determines that resources 1110, 1112 and 1114 are available candidate resources and a resource 1120 is reserved by a second UE. The candidate resource 1112 is prior to the reserved resource 1120. If the first UE selects the candidate resource 1112 for a first sidelink transmission, the first sidelink transmission may disrupt an LBT procedure performed by a second UE for a second sidelink transmission on the reserved resource 1120.

An additional issue is that the first UE may not know information about the LBT procedure to be performed by the second UE, which makes it hard to infer whether it will disrupt the LBT procedure when using a candidate resource preceding the reserved resource.

The issue is more severe when a Tx UE wanting to perform a transmission on the reserved resource has to apply an LBT type 1 procedure with a high CAPC, which relates to a longer CW and LBT time, not fitting into the guard period of the candidate resources.

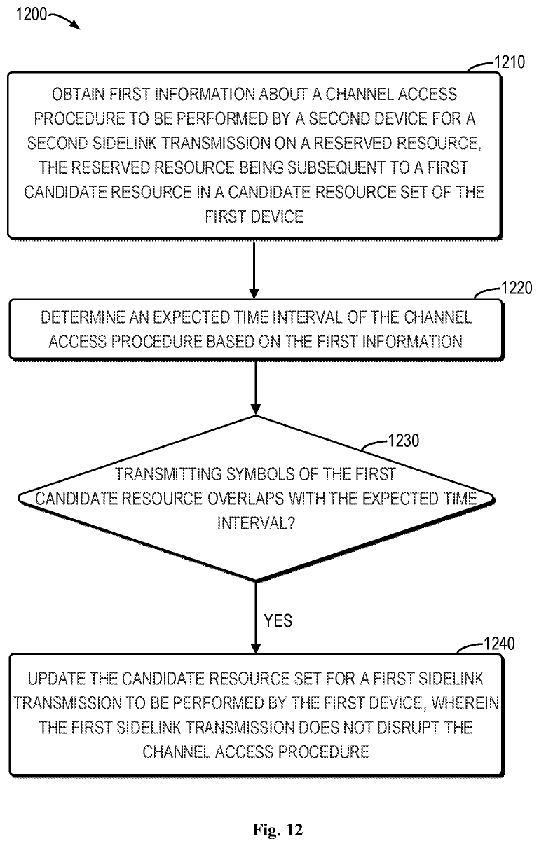

Implementations of the present disclosure provide a solution for SL resource selection so as to solve the above problems and one or more of other potential problems. According to the solution, a first device performing sensing-based resource allocation (such as NR SL mode 2) takes into account an expected LBT procedure duration or interval associated with the LBT procedure of a second device which has reserved resources located after a candidate resource. More specifically, the first device determines whether the LBT procedure of the second device associated with a transmission on a reserved resource overlaps with occupied symbols of a candidate resource for the first device. Based on this determination, the first device updates a candidate resource set in order to prevent causing LBT disruption to the transmission of the second device on the reserved resource. Hereinafter, principle of the present disclosure will be described with reference to FIGS. 12 to 16.

FIG. 12 illustrates a flowchart of an example method 1200 in accordance with some implementations of the present disclosure. In some implementations, the method 1200 can be implemented at a device, such as the device 110 or the device 120 as shown in FIG. 1. For the purpose of discussion, the method 1200 will be described with reference to FIG. 1 as performed by the first device 110 without loss of generality.

At block 1210, the first device 110 obtains first information about a channel access procedure to be performed by the second device 120 for a second sidelink transmission on a reserved resource. The reserved resource is subsequent to a first candidate resource in a candidate resource set of the first device 110.

In some embodiments, the reserved resource may be immediately subsequent to the first candidate resource.

In other embodiments, the reserved resource may be not immediately subsequent to the first candidate resource. In such embodiments, the reserved resource may comprise a plurality of slots after the candidate resource and the channel access procedure may still be disrupted. For example, with CAPC 4, the contention window size can take more than one slot. Accordingly, a time interval of the channel access procedure may take more than one slot. Thus, the channel access procedure may still be disrupted by transmission on the first candidate resource.

In some embodiments, the first information about the channel access procedure comprises at least one of the following:
a type of the channel access procedure,
a CAPC for the second sidelink transmission,
a CW size associated with the channel access procedure,
a current value of a CW countdown counter,
an expected gap before the reserved resource (for example, the expected gap may be indicated in number of symbols),
an indication of expected COT availability (for example, the expectation of the COT being acquired prior to the reserved resource and/or remaining channel occupancy time), or
a priority for the second sidelink transmission.

In some embodiments, the first device 110 may receive the first information from the second device 120. In such embodiments, the first information may comprise reserved resource channel access information. In addition, in such embodiments, the first device 110 may receive the first information in SCI format 1-A.

In some embodiments, the first information about the channel access procedure may comprise the priority for the second sidelink transmission. In such embodiments, the first device 110 may determine the CAPC for the second sidelink transmission based on the priority. Then, the first device 110 may determine the CW size based on the CAPC. For example, the first device 110 may determine the CW size based on the CAPC by using Table 1 as described above. In turn, the first device 110 may determine the expected time interval of the channel access procedure based on the CW size.

In such embodiments, the CAPC for the second sidelink transmission may be predefined based on a certain rule. For example, a high transmission priority may be associated with a low CAPC value and vice-versa. Where a low CAPC value corresponds to a low CWS which in turn may be contained within a guard symbol of the previous SL slot. The information on the transmission priority may be obtained from a priority field in the first stage SCI.

In some embodiments, in order to obtain the first information about the channel access procedure, the first device 110 may obtain second information about sharing first COT from a third device toward the second device 120. The second information may indicate a type of the channel access procedure. For example, the first device 110 may obtain the second information in the first stage SCI. In case where the first COT is shared by the third device with the second device 120, the type of the channel access procedure to be performed by the second device 120 may be a type 2 channel access procedure (also referred to as LBT type 2 procedure). In turn, the first device 110 may determine the expected time interval of the channel access procedure based on the type of the channel access procedure. In such embodiments, the third device may be a terminal device or a network device

In some embodiments, in response to detecting that a second free candidate resource precedes the reserved resource, the first device 110 may determine whether the first device 110 can acquire second COT that can be shared with the second device 120. If the first device 110 can acquire the second COT that can be shared with the second device 120, the first device 110 may share the second COT with the second device 120. In turn, the first device 110 may determine the expected time interval of the channel access procedure based on the sharing.

In some embodiments, the first device 110 may determine whether the first device 110 can acquire the second COT that can be shared with the second device 120 by determining whether the second device 120 can detect a shared COT when the second COT has been acquired on the second free candidate resource.

In other embodiments, alternatively, the first device 110 may determine whether the first device 110 can acquire the second COT that can be shared with the second device 120 by determining whether the first device 110 can acquire and share the second COT at least a second number of slots before transmission of the second device 120. A duration of the second COT may be longer than the second number of slots. In such embodiments, the first device 110 may require the second number of slots to detect the second COT.

At block 1220, the first device 110 determines an expected time interval of the channel access procedure based on the first information. Hereinafter, an expected time interval of the channel access procedure is also referred to as an LBT duration.

At block 1230, the first device 110 determines whether transmitting symbols of the first candidate resource overlap with the expected time interval.

If the transmitting symbols of the first candidate resource overlap with the expected time interval, the first device 110 updates, at block 1240, the candidate resource set for a first sidelink transmission to be performed by the first device 110. The first sidelink transmission does not disrupt the channel access procedure. In other words, the first device 110 updates the candidate resource set in such a way that the first sidelink transmission does not disrupt the channel access procedure.

On the other hand, in some embodiments, if the transmitting symbols of the first candidate resource do not overlap with the expected time interval, the first device 110 may select the first candidate resource for the first sidelink transmission as usual. For example, if the expected time interval may fit in a guard period of the first candidate resource, 110 may select the first candidate resource for the first sidelink transmission as usual.

The method 1200 may avoid that the first device disrupts the LBT procedure of the second device that have already reserved resource for SL transmission, which is desired especially when the reserved resource is for a higher priority transmission. This may improve the coexistence between different SL devices operating in the unlicensed spectrum.

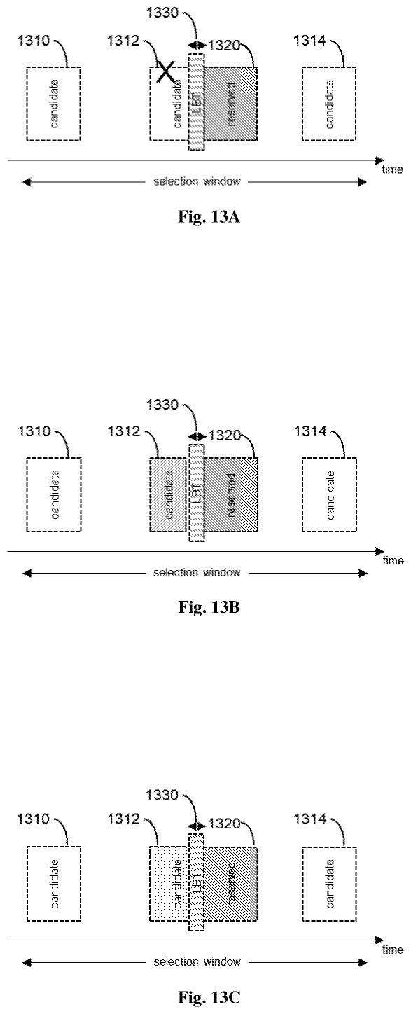

In some embodiments, the first device 110 may update the candidate resource set by excluding the first candidate resource from the candidate resource set. This will be described with reference to FIG. 13A.

FIG. 13A illustrates an example of SL resource selection in accordance with some implementations of the present disclosure. The first device 110 constructs a candidate resource set by monitoring a resource pool activity during a sensing period and from there determines which single-slot (or N-consecutive-slot) resources during the selection period are expected to be free (i.e., single-slot or N-consecutive-slot resources for which no reservation was detected during the sensing period). In this example, the first device 110 determines that candidate resources 1310, 1312 and 1314 in the candidate resource set are free. Based on SCI received from the second device 120, the first device 110 determines that a resource 1320 is reserved by a second device 120. Hereinafter, a resource which is reserved by a device is also referred to as a reserved resource. Just by way of example, the candidate resource 1312 is immediately prior to the reserved resource 1320.

Based on first information about an LBT procedure to be performed by the second device 120 for a second sidelink transmission on the reserved resource 1320, the first device 110 determines an expected time interval 1330 of the LBT procedure.

Further, the first device 110 determines that transmitting symbols of the candidate resource 1312 overlap with the expected time interval 1330. In this case, if the first device 110 selects the candidate resource 1312 for a first sidelink transmission, the first sidelink transmission may disrupt the LBT procedure to be performed by the second device 120 for the second sidelink transmission on the reserved resource 1320. In order to avoid disrupting the LBT procedure, the first device 110 may exclude the candidate resource 1312 from the candidate resource set.

In some embodiments, the first device 110 may exclude the first candidate resource if at least one of the following is met:
the first candidate resource overlapping with the expected time interval of a channel access procedure,
the reserved resource comprising a first number of symbols on which the channel access procedure is to be performed, the first number exceeding a first threshold, or
a second priority of the second sidelink transmission being equal to or higher than a first priority of a first sidelink transmission on the first candidate resource, or
the number of candidate resources in the candidate resource set exceeding a second threshold.

In some embodiments, the first device 110 may update the candidate resource set by including the first candidate resource in the candidate resource set. In such embodiments, the first device 110 may include the first candidate resource in the candidate resource set by shortening the first candidate resource in time domain. This will be described with reference to FIG. 13B.

FIG. 13B illustrates an example of SL resource selection in accordance with some implementations of the present disclosure. The example in FIG. 13B is similar to the example in FIG. 13A in that the first device 110 determines that transmitting symbols of the candidate resource 1312 overlap with the expected time interval 1330. The example in FIG. 13B is different from the example in FIG. 13A in that the first device 110 includes the first candidate resource in the candidate resource set by shortening the first candidate resource in time domain.

In some embodiments, the first candidate resource comprises a single slot. In such embodiments, the first device 110 may shorten the first candidate resource in time domain by puncturing the last symbols of the single slot.

In some embodiments, the first candidate resource comprises a plurality of consecutive slots. In such embodiments, the first device 110 may shorten the first candidate resource in time domain by puncturing or applying a guard period at the slots or the symbols of the slots among the consecutive slots which overlap with the expected time interval of the channel access procedure. For example, in case where the first candidate resource comprises N consecutive slots, the first device 110 may puncture the last m slots (with m<N) such that the first sidelink transmission is performed on (N−m)-contiguous-slot resources.

It will be understood that the puncturing may means that the first device shuts off a transmitter of the first device during the punctured symbols or slots, or transmitting with zero power, or excluding the part of the resources of the first sidelink transmission.

In some embodiments, alternatively, the first device 110 may include the first candidate resource in the candidate resource set by applying a longer guard period for the first candidate resource.

In some embodiments, alternatively, the first device 110 may include the first candidate resource in the candidate resource set by applying a slot structure for the first candidate resource so that the transmitting symbols do not overlap with the expected time interval. For example, the first device 110 may apply the slot structure without PSFCH as shown in the example of FIG. 10.

In some embodiments, alternatively, the first device 110 may include the first candidate resource in the candidate resource set by applying a shorter transmission length for the first candidate resource.

In some embodiments, alternatively, the first device 110 may include the first candidate resource in the candidate resource set by applying a reduced power for transmission on the first candidate resource. This will be described with reference to FIG. 13C.

FIG. 13C illustrates an example of SL resource selection in accordance with some implementations of the present disclosure. Similar to the example in FIG. 13B, in the example in FIG. 13C, the first device 110 determines that transmitting symbols of the candidate resource 1312 overlap with the expected time interval 1330 and includes the first candidate resource in the candidate resource set. The example in FIG. 13C is different from the example in FIG. 13B in that the first device 110 includes the first candidate resource in the candidate resource set by applying a reduced power for transmission on the first candidate resource.

In embodiments where the first device 110 shortens the first candidate resource in time domain or applies the reduced power for the transmission on the first candidate resource, in order to compensate the reduced power, the first device 110 may apply an repetition of the transmission on a third candidate resource in the candidate resource set.

Alternatively, in order to compensate the reduced power, the first device 110 may expand the first candidate resource in frequency domain by occupying at least one additional subchannel.

Alternatively, in order to compensate the reduced power, the first device 110 may select a Modulation and Coding Scheme (MCS) in which the first transmission fits in the first candidate resource.

In some embodiments, there may be multiple reserved resources with different expected LBT durations overlapping with candidate resources, the first device 110 may consider the longest expected LBT duration, or the LBT duration of the resources of the transmissions with an equal or higher priority.

In some embodiments, the method 1200 may be performed in a resource re-selection or re-evaluation procedure when the first device 110 has already select one or more resources and later the first device 110 detects that a resource reservation (for example, for a higher priority transmission) succeeding the selected resource. Then, the first device 110 may apply the actions in blocks 1210 to 1240 to determine and avoid disrupting the LBT associated to the reserved transmission. The selected resources which overlap with LBT duration for the higher priority transmission on the reserved resource may be deemed pre-empted.

In some embodiments, the determination of whether the expected LBT duration will overlap with the transmitting symbols of the first candidate resource may depend on the subcarrier spacing (SCS). Since a larger SCS is associated with a shorter symbol duration, and consequentially, the larger SCS is associated with a shorter guard period. An LBT procedure of a given duration (in microseconds) will occupy more symbols with a larger SCS.

In some embodiments, the method 1200 may be applied with interlaced resource allocation.

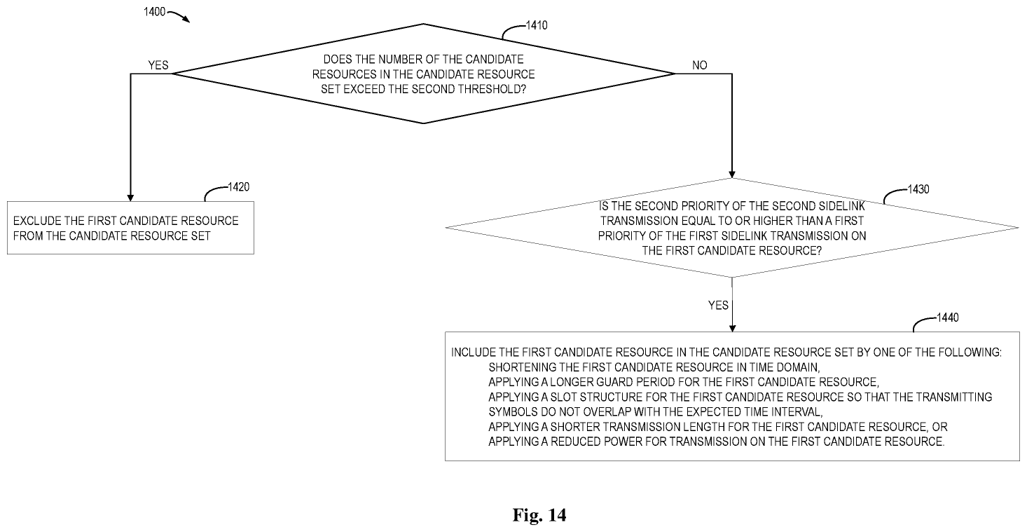

As mentioned above, the first device 110 may excludes the first candidate resource if the number of remaining candidate resources in the candidate resource set exceeds the second threshold. This will be described with reference to FIG. 14.

FIG. 14 illustrates a flowchart of an example method 1400 in accordance with some implementations of the present disclosure. In some implementations, the method 1400 can be implemented at a device, such as the device 110 or the device 120 as shown in FIG. 1.

For the purpose of discussion, the method 1400 will be described with reference to FIG. 1 as performed by the first device 110 without loss of generality.

At block 1410, the first device 110 determines whether the number of remaining candidate resources in the candidate resource set exceeds the second threshold.

If the number of remaining candidate resources in the candidate resource set exceeds the second threshold, the first device 110 excludes, at block 1420, the first candidate resource from the candidate resource set.

On the other hand, if the number of remaining candidate resources in the candidate resource set does not exceed the second threshold, the first device 110 determines, at block 1430, whether the second priority of the second sidelink transmission is equal to or higher than a first priority of the first sidelink transmission on the first candidate resource.

If the second priority of the second sidelink transmission is equal to or higher than the first priority of the first sidelink transmission on the first candidate resource, the first device 110 includes, at block 1440, the first candidate resource in the candidate resource set by one of the following: shortening the first candidate resource in time domain, applying a longer guard period for the first candidate resource, applying a slot structure for the first candidate resource so that the transmitting symbols do not overlap with the expected time interval, applying a shorter transmission length for the first candidate resource, or applying a reduced power for transmission on the first candidate resource.

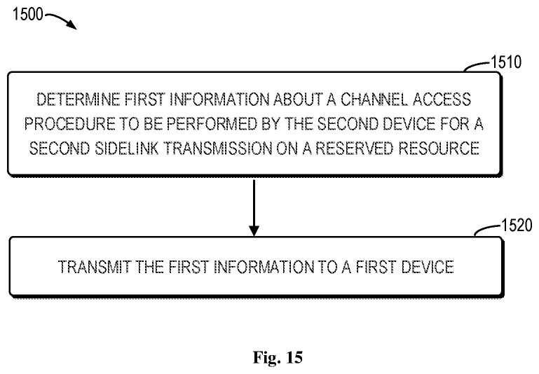

FIG. 15 illustrates a flowchart of an example method 1500 in accordance with some implementations of the present disclosure. In some implementations, the method 1500 can be implemented at a device, such as the device 110 or the device 120 as shown in FIG. 1. For the purpose of discussion, the method 1500 will be described with reference to FIG. 1 as performed by the second device 120 without loss of generality.

At block 1510, the second device 120 determines first information about a channel access procedure to be performed by the second device 120 for a second sidelink transmission on a reserved resource.

At block 1520, the second device 120 transmits the first information to a first device.

In some embodiments, the first information comprises reserved resource channel access information.

In some embodiments, the second device 120 may transmit the first information in SCI format 1-A.

It shall be understood that the embodiments which have been described with respect to method 1200 may be applied to the method 1500. Thus, details of the embodiments are omitted for brevity.

In some example implementations, an apparatus capable of performing any of the method 1200 (for example, an apparatus) may comprise means for performing the respective steps of the method 1200. The means may be implemented in any suitable form. For example, the means may be implemented in a circuitry or software module.

In some example implementations, the apparatus comprises: means for obtaining, at a first device, first information about a channel access procedure to be performed by a second device for a second sidelink transmission on a reserved resource, the reserved resource being subsequent to a first candidate resource in a candidate resource set of the first device; means for determining an expected time interval of the channel access procedure based on the first information; and means for updating the candidate resource set for a first sidelink transmission to be performed by the first device in accordance with a determination that transmitting symbols of the first candidate resource overlaps with the expected time interval, wherein the first sidelink transmission does not disrupt the channel access procedure.

In some example implementations, the means for updating the candidate resource set comprises: means for excluding the first candidate resource from the candidate resource set, or means for including the first candidate resource in the candidate resource set by one of the following: shortening the first candidate resource in time domain, applying a longer guard period for the first candidate resource, applying a slot structure for the first candidate resource so that the transmitting symbols do not overlap with the expected time interval, applying a shorter transmission length for the first candidate resource, or applying a reduced power for transmission on the first candidate resource.

In some example implementations, the means for excluding the first candidate resource comprises: means for excluding the first candidate resource in accordance with a determination that at least one of the following is met: the first candidate resource overlapping with the expected time interval of the channel access procedure, the reserved resource comprising a first number of symbols on which the channel access procedure is to be performed, the first number exceeding a first threshold, or a second priority of the second sidelink transmission being equal to or higher than a first priority of the first sidelink transmission on the first candidate resource, or the number of candidate resources in the candidate resource set exceeding a second threshold.

In some example implementations, the first candidate resource comprises a single slot; and shortening the first candidate resource comprises: shortening the first candidate resource in time domain by puncturing the last symbols of the single slot.

In some example implementations, the first candidate resource comprises a plurality of consecutive slots; and shortening the first candidate resource comprises: shortening the first candidate resource in time domain by puncturing or applying a guard period at the slots or the symbols of the slots among the consecutive slots which overlap with the expected time interval of the channel access procedure.

In some example implementations, the means for including the first candidate resource in the candidate resource set comprises: means for shortening the first candidate resource in time domain or applying the reduced power for the transmission on the first candidate resource; and the apparatus further comprises means for performing at least one of the following: applying an repetition of the transmission on a third candidate resource in the candidate resource set; or expanding the first candidate resource in frequency domain by occupying at least one additional subchannel; or selecting a Modulation and Coding Scheme in which the first transmission fits in the first candidate resource.

In some example implementations, the first information about the channel access procedure comprises at least one of the following: a type of the channel access procedure, a channel access priority class (CAPC) for the second sidelink transmission, a contention window (CW) size associated with the channel access procedure, a current value of a CW countdown counter, an expected gap before the reserved resource, an indication of expected channel occupancy time (COT) availability, or a priority for the second sidelink transmission.

In some example implementations, the means for obtaining the first information about the channel access procedure comprises: means for receiving the first information from the second device.

In some example implementations, the first information about the channel access procedure comprises the priority for the second sidelink transmission; and means for determining the expected time interval of the channel access procedure comprises: means for determining the CAPC for the second sidelink transmission based on the priority; means for determining the CW size based on the CAPC; and means for determining the expected time interval of the channel access procedure based on the CW size.

In some example implementations, the means for obtaining the first information about the channel access procedure comprises: means for obtaining second information about sharing first channel occupancy time (COT) from a third device toward the second device, the second information indicating a type of the channel access procedure; and means for determining the expected time interval of the channel access procedure comprises: means for determining the expected time interval of the channel access procedure based on the type of the channel access procedure.

In some example implementations, means for determining the expected time interval of the channel access procedure comprises: in response to detecting that a second free candidate resource precedes the reserved resource, means for determining whether the first device can acquire second channel occupancy time (COT) that can be shared with the second device; in accordance with a determination that the first device can acquire the second COT that can be shared with the second device, means for sharing the second COT with the second device; and means for determining the expected time interval of the channel access procedure based on the sharing.

In some example implementations, means for determining whether the first device can acquire the second COT that can be shared with the second device comprises: means for determining whether the second device can detect a shared COT when the second COT has been acquired on the second free candidate resource; or means for determining whether the first device can acquire and share the second COT at least a second number of slots before transmission of the second device, a duration of the second COT being longer than the second number of slots.

In some embodiments or implementations, the method may be applied for determination of preferred resources, non-preferred resources or conflicting resources in a inter UE coordination (IUC) scheme. In IUC scheme 1, the IUC information sent from a second UE to a first UE is a set of resources which is preferred or non-preferred for first UE transmission. In IUC scheme 2, the IUC information is an indication of an expected or potential resource collision. For example, for the IUC information for the non-preferred resources or resource collision, the second UE informs the first UE about the candidate resources which may overlap with an expected time interval of channel access procedure. Alternatively, for the IUC information for the preferred resources, the second UE informs the first UE that the candidate resources may not overlap with the expected time interval of channel access procedure.

In some example implementations, an apparatus capable of performing any of the method 1500 (for example, an apparatus) may comprise means for performing the respective steps of the method 1500. The means may be implemented in any suitable form. For example, the means may be implemented in a circuitry or software module.

In some example implementations, the apparatus comprises: means for determining, at a second device, first information about a channel access procedure to be performed by the second device for a second sidelink transmission on a reserved resource; and means for transmitting the first information to a first device.

In some example implementations, the first information about the channel access procedure comprises at least one of the following: a type of the channel access procedure, a channel access priority class (CAPC) for the second sidelink transmission, a contention window (CW) size associated with the channel access procedure, a current value of a CW countdown counter, an expected gap before the reserved resource, an indication of expected channel occupancy time (COT) availability, or a priority for the second sidelink transmission.

In some example implementations, the first information comprises reserved resource channel access information.

In some example implementations, the means for transmitting the first information comprises: means for transmitting the first information in sidelink control information (SCI) format 1-A.

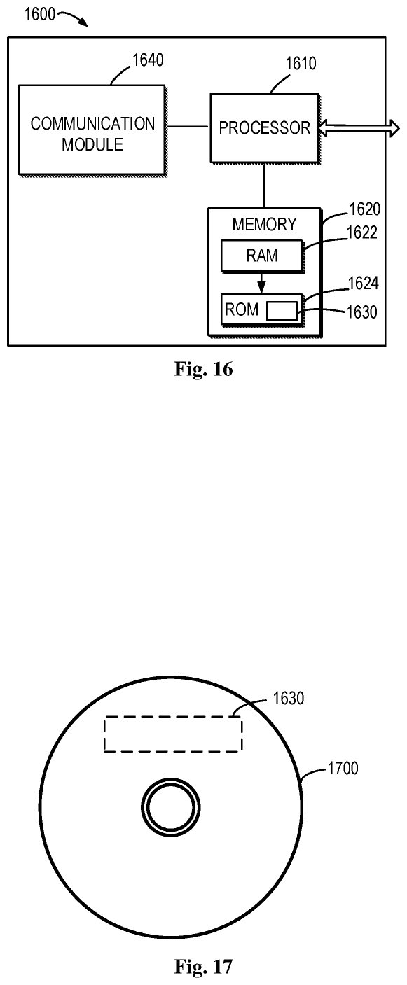

FIG. 16 is a simplified block diagram of a device 1600 that is suitable for implementing embodiments of the present disclosure. The device 1600 may be provided to implement the communication device, for example, the first device 110 or the second device 120 as shown in FIG. 1. As shown, the device 1600 includes one or more processors 1610, one or more memories 1620 coupled to the processor 1610, and one or more communication modules 1640 coupled to the processor 1610.

The communication module 1640 is for bidirectional communications. The communication module 1640 has at least one antenna to facilitate communication. The communication interface may represent any interface that is necessary for communication with other network elements.

The processor 1610 may be of any type suitable to the local technical network and may include one or more of the following: general purpose computers, special purpose computers, microprocessors, digital signal processors (DSPs) and processors based on multicore processor architecture, as non-limiting examples. The device 1600 may have multiple processors, such as an application specific integrated circuit chip that is slaved in time to a clock which synchronizes the main processor.

The memory 1620 may include one or more non-volatile memories and one or more volatile memories. Examples of the non-volatile memories include, but are not limited to, a Read Only Memory (ROM) 1624, an electrically programmable read only memory (EPROM), a flash memory, a hard disk, a compact disc (CD), a digital video disk (DVD), and other magnetic storage and/or optical storage. Examples of the volatile memories include, but are not limited to, a random access memory (RAM) 1622 and other volatile memories that will not last in the power-down duration.

A computer program 1630 includes computer executable instructions that are executed by the associated processor 1610. The program 1630 may be stored in the ROM 1624. The processor 1610 may perform any suitable actions and processing by loading the program 1630 into the RAM 1622.

The embodiments of the present disclosure may be implemented by means of the program 1630 so that the device 1600 may perform any process of the disclosure as discussed with reference to FIGS. 1 to 15. The embodiments of the present disclosure may also be implemented by hardware or by a combination of software and hardware.

In some example embodiments, the program 1630 may be tangibly contained in a computer readable medium which may be included in the device 1600 (such as in the memory 1620) or other storage devices that are accessible by the device 1600. The device 1600 may load the program 1630 from the computer readable medium to the RAM 1622 for execution. The computer readable medium may include any types of tangible non-volatile storage, such as ROM, EPROM, a flash memory, a hard disk, CD, DVD, and the like. FIG. 17 shows an example of the computer readable medium 1700 in form of CD or DVD. The computer readable medium has the program 1630 stored thereon.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the methods 1200, 1400 and 1500 as described above with reference to FIGS. 12, 14 and 15. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program codes or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1.-20. (canceled)

21. An apparatus comprising:
a processor; and
a memory comprising computer-executable instructions that, when executed by the processor, cause the processor to perform the following:
obtaining, at a first device, first information about a channel access procedure to be performed by a second device for a second sidelink transmission on a reserved resource, the reserved resource being subsequent to a first candidate resource in a candidate resource set of the first device, wherein the first information about the channel access procedure comprises the following: a type of the channel access procedure, a channel access priority class (CAPC) for the second sidelink transmission, a contention window (CW) size associated with the channel access procedure, a current value of a CW countdown counter, an expected gap before the reserved resource, an indication of expected channel occupancy time (COT) availability, and a priority for the second sidelink transmission;
determining an expected time interval of the channel access procedure based on the first information; and
in accordance with a determination that transmitting symbols of the first candidate resource overlaps with the expected time interval, updating the candidate resource set for a first sidelink transmission to be performed by the first device, wherein the first sidelink transmission does not disrupt the channel access procedure, wherein updating the candidate resource set comprises including the first candidate resource in the candidate resource set by:
shortening the first candidate resource in time domain,
applying a longer guard period for the first candidate resource,
applying a slot structure for the first candidate resource so that the transmitting symbols do not overlap with the expected time interval,
applying a shorter transmission length for the first candidate resource, and
applying a reduced power for transmission on the first candidate resource; and
applying a repetition of the transmission on a third candidate resource in the candidate resource set;
expanding the first candidate resource in frequency domain by occupying at least one additional subchannel; and
selecting a Modulation and Coding Scheme in which the first transmission fits in the first candidate resource.

22. The apparatus of claim 21, wherein the first candidate resource comprises a single slot; and
shortening the first candidate resource comprises:
shortening the first candidate resource in time domain by puncturing last symbols of the single slot.

23. The apparatus of claim 21, wherein the first candidate resource comprises a plurality of consecutive slots; and
shortening the first candidate resource comprises:
shortening the first candidate resource in time domain by puncturing or applying a guard period at slots or symbols of the slots among the consecutive slots which overlap with the expected time interval of the channel access procedure.

24. The apparatus of claim 23, wherein obtaining the first information about the channel access procedure comprises:
receiving the first information from the second device.

25. The apparatus of claim 24, wherein the first information about the channel access procedure comprises the priority for the second sidelink transmission; and
determining the expected time interval of the channel access procedure comprises:
determining the CAPC for the second sidelink transmission based on the priority;
determining the CW size based on the CAPC; and
determining the expected time interval of the channel access procedure based on the CW size.

26. The apparatus of claim 25, wherein:
obtaining the first information about the channel access procedure comprises:
obtaining second information about sharing first channel occupancy time (COT) from a third device toward the second device, the second information indicating a type of the channel access procedure; and
determining the expected time interval of the channel access procedure further comprises:
determining the expected time interval of the channel access procedure based on the type of the channel access procedure.

27. The apparatus of claim 21, wherein determining the expected time interval of the channel access procedure comprises:
in response to detecting that a second free candidate resource precedes the reserved resource, determining whether the first device can acquire second channel occupancy time (COT) that can be shared with the second device;
in accordance with a determination that the first device can acquire the second COT that can be shared with the second device, sharing the second COT with the second device; and
determining the expected time interval of the channel access procedure based on the sharing.

28. The apparatus of claim 27, wherein determining whether the first device can acquire the second COT that can be shared with the second device comprises:
determining whether the second device can detect a shared COT when the second COT has been acquired on the second free candidate resource; or
determining whether the first device can acquire and share the second COT at least a second number of slots before transmission of the second device, a duration of the second COT being longer than the second number of slots.

29. A system comprising:
an apparatus comprising:
a processor; and
a memory comprising computer-executable instructions that, when executed by the processor, cause the processor to perform the following:
obtaining, at a first device, first information about a channel access procedure to be performed by a second device for a second sidelink transmission on a reserved resource, the reserved resource being subsequent to a first candidate resource in a candidate resource set of the first device, wherein the first information about the channel access procedure comprises the following: a type of the channel access procedure, a channel access priority class (CAPC) for the second sidelink transmission, a contention window (CW) size associated with the channel access procedure, a current value of a CW countdown counter, an expected gap before the reserved resource, an indication of expected channel occupancy time (COT) availability, and a priority for the second sidelink transmission;
determining an expected time interval of the channel access procedure based on the first information; and
in accordance with a determination that transmitting symbols of the first candidate resource overlaps with the expected time interval, updating the candidate resource set for a first sidelink transmission to be performed by the first device, wherein the first sidelink transmission does not disrupt the channel access procedure, wherein updating the candidate resource set comprises including the first candidate resource in the candidate resource set by:
shortening the first candidate resource in time domain,
applying a longer guard period for the first candidate resource,
applying a slot structure for the first candidate resource so that the transmitting symbols do not overlap with the expected time interval,
applying a shorter transmission length for the first candidate resource, and
applying a reduced power for transmission on the first candidate resource; and
applying a repetition of the transmission on a third candidate resource in the candidate resource set;
expanding the first candidate resource in frequency domain by occupying at least one additional subchannel; and
selecting a Modulation and Coding Scheme in which the first transmission fits in the first candidate resource.

30. The system of claim 29, wherein the first candidate resource comprises a single slot; and
shortening the first candidate resource comprises:
shortening the first candidate resource in time domain by puncturing last symbols of the single slot.

31. The system of claim 29, wherein the first candidate resource comprises a plurality of consecutive slots; and
shortening the first candidate resource comprises:
shortening the first candidate resource in time domain by puncturing or applying a guard period at slots or symbols of the slots among the consecutive slots which overlap with the expected time interval of the channel access procedure.

32. The system of claim 31, wherein obtaining the first information about the channel access procedure comprises:
receiving the first information from the second device.

33. The system of claim 32, wherein the first information about the channel access procedure comprises the priority for the second sidelink transmission; and
determining the expected time interval of the channel access procedure comprises:
determining the CAPC for the second sidelink transmission based on the priority;
determining the CW size based on the CAPC; and
determining the expected time interval of the channel access procedure based on the CW size.

34. The system of claim 33, wherein:
obtaining the first information about the channel access procedure comprises:
obtaining second information about sharing first channel occupancy time (COT) from a third device toward the second device, the second information indicating a type of the channel access procedure; and
determining the expected time interval of the channel access procedure further comprises:
determining the expected time interval of the channel access procedure based on the type of the channel access procedure.

35. The system of claim 29, wherein determining the expected time interval of the channel access procedure comprises:
in response to detecting that a second free candidate resource precedes the reserved resource, determining whether the first device can acquire second channel occupancy time (COT) that can be shared with the second device;
in accordance with a determination that the first device can acquire the second COT that can be shared with the second device, sharing the second COT with the second device; and
determining the expected time interval of the channel access procedure based on the sharing.

36. The system of claim 35, wherein determining whether the first device can acquire the second COT that can be shared with the second device comprises:
determining whether the second device can detect a shared COT when the second COT has been acquired on the second free candidate resource; or
determining whether the first device can acquire and share the second COT at least a second number of slots before transmission of the second device, a duration of the second COT being longer than the second number of slots.

37. A method comprising:
obtaining, at a first device, first information about a channel access procedure to be performed by a second device for a second sidelink transmission on a reserved resource, the reserved resource being subsequent to a first candidate resource in a candidate resource set of the first device, wherein the first information about the channel access procedure comprises the following: a type of the channel access procedure, a channel access priority class (CAPC) for the second sidelink transmission, a contention window (CW) size associated with the channel access procedure, a current value of a CW countdown counter, an expected gap before the reserved resource, an indication of expected channel occupancy time (COT) availability, and a priority for the second sidelink transmission;
determining an expected time interval of the channel access procedure based on the first information; and
in accordance with a determination that transmitting symbols of the first candidate resource overlaps with the expected time interval, updating the candidate resource set for a first sidelink transmission to be performed by the first device, wherein the first sidelink transmission does not disrupt the channel access procedure, wherein updating the candidate resource set comprises including the first candidate resource in the candidate resource set by:
shortening the first candidate resource in time domain,
applying a longer guard period for the first candidate resource,
applying a slot structure for the first candidate resource so that the transmitting symbols do not overlap with the expected time interval,
applying a shorter transmission length for the first candidate resource, and
applying a reduced power for transmission on the first candidate resource; and
applying a repetition of the transmission on a third candidate resource in the candidate resource set;
expanding the first candidate resource in frequency domain by occupying at least one additional subchannel; and
selecting a Modulation and Coding Scheme in which the first transmission fits in the first candidate resource.

38. The method of claim 37, wherein the first candidate resource comprises a plurality of consecutive slots; and
shortening the first candidate resource comprises:
shortening the first candidate resource in time domain by puncturing or applying a guard period at slots or symbols of the slots among the consecutive slots which overlap with the expected time interval of the channel access procedure.

39. The method of claim 38, wherein the first information about the channel access procedure comprises the priority for the second sidelink transmission; and
determining the expected time interval of the channel access procedure comprises:
determining the CAPC for the second sidelink transmission based on the priority;
determining the CW size based on the CAPC; and
determining the expected time interval of the channel access procedure based on the CW size.

40. The apparatus of claim 39, wherein:
obtaining the first information about the channel access procedure comprises:
obtaining second information about sharing first channel occupancy time (COT) from a third device toward the second device, the second information indicating a type of the channel access procedure; and
determining the expected time interval of the channel access procedure further comprises:
determining the expected time interval of the channel access procedure based on the type of the channel access procedure.
